(19) United States
(12) Patent Application Publication
(10) Pub. No.: US 2004/0002403 A1
(43) Pub. Date: Jan. 1, 2004

(54) Drive transmission

(76) Inventor: Simon Blair Dobson, Sandgate (GB)

Correspondence Address: CARLSON, GASKEY & OLDS, P.C., 400 WEST MAPLE ROAD, SUITE 350, BIRMINGHAM, MI, 48009, US

(21) Appl. No.: 10/407,835

(22) Filed: Apr. 4, 2003

(30) Foreign Application Priority Data
Apr. 5, 2002 (GB) 0207880.6

(51) Int. Cl. F16H 23/00

(52) U.S. Cl. 475/163

(57) ABSTRACT

A drive transmission has a rotary drive input member that is inclined with respect to its axis of rotation and that is driven by a motor. A first gear is mounted on the drive input member and engages with a rotatable second gear and a fixed third gear. Rotation of the drive input member causes the first gear to rock while the second gear provides a rotary drive output for the drive transmission.

### REFERENCE TO RELATED APPLICATIONS

The present invention claims priority to United Kingdom (GB) patent application number 0207880.6, filed Apr. 5, 2002.

### BACKGROUND OF THE INVENTION

The invention relates to a drive transmission, and more particularly to a drive transmission designed to have a compact structure.

Electric motors typically provide a high rotational speed but low torque. However, many automotive applications, such as the raising and lowering of a vehicle window panel, require low speed coupled with a high torque for operation. Because of this, most applications includes a drive transmission, such as a gearbox, that converts the electric motor output to obtain the required reduction ratio. For example, a typical electric motor for raising and lowering a window panel may produce a torque of around 0.36Nm at 7300 rpm. By providing a drive transmission with a reduction ratio of, for example, 73:1, a torque output of 12Nm at 100 rpm, which is suitable for raising and lowering a vehicle window panel, can be achieved.

Packaging requirements for some vehicle doors can make it difficult to locate an electric motor and drive transmission assembly. Until recently, the usual practice in the art was to develop electric motors and drive transmissions oriented in the axial direction.

In other words, the radial dimension of the assembly was small compared to its axial length. The resulting length forced the motor and drive transmission assembly to be installed in the vehicle door with the axis of the assembly parallel to the window panel being opened and closed. This structure required turning the drive transmission ninety degrees to enable it to drive, for example, a pinion enmeshed with a sector gear for raising and lowering the window panel.

More recently, electric motors known as “pancake motors” have been developed.

These types of motors have a radial dimension that is large compared to its axial length.

For example, a pancake motor of 80-100 mm diameter may be only 20-30 mm in the axial direction. These proportions enable a pancake motor to be installed in a vehicle door with its axis of rotation transverse to the window panel. However, a drive transmission still needs to be added and a shorter drive transmission is required if the entire assembly is to extend axially in a direction transverse to the window panel.

WO-A-01/20753 describes a pancake motor and a drive transmission having a radial structure, where the drive transmission is axially quite short when compared to its radial dimension. The embodiments shown in WO-A-01/20753 enable a pancake motor/drive transmission assembly to be arranged with its axis of rotation extending in a direction transverse to a window panel. However, the transmissions described comprise complex epicyclic arrangements of pinions and internally toothed annulus gears.

A reduction drive transmission is described in U.S. Pat. No 3,428,839. The transmission comprises a rotatable bevel gear which is driven by another bevel gear mounted for nutating motion, which provides a reduction drive ratio. The nutating motion itself is effected by a plurality of electromagnets. The need to provide a plurality of electromagnets leads again to a complex arrangement. Moreover, reliability appears to be a problem because the possibility of the electromagnets needing replacement as a result of breakdown or burnout is specifically mentioned in U.S. Pat. No. 3 428 839. In fact, this structure requires a removable cover plate to provide access to the electromagnets, and the breakdown of only one electromagnet produces problems in the drive transmission's operation.

An object of the present invention is to provide a drive transmission which is suitable for use with a pancake motor, which is not as complex as those in WO-A-01/20753 and U.S. Pat. No. 3 428 839 and which can still be made axially short compared to its radial size.

### SUMMARY OF THE INVENTION

A drive transmission according to one embodiment of the invention comprises a rotary drive input member for receiving a drive output from a motor, a first gear driveable by the rotary drive input to nutate in a rocking manner, and a second gear that engages with the first gear to provide a rotary drive output for the transmission. In one embodiment, the second gear is housed within and driveably connected to a window regulator cable drum having a helical groove for driving a window regulator cable.

The use of a rocking gear simplifies the structure of the drive transmission and operates more reliably than previously known structures. When the inventive drive assembly is used in conjunction with a pancake motor, a very compact arrangement can be produced, making it particularly useful for applications where space is at a premium, such as inside vehicle doors.

### BRIEF DESCRIPTION OF THE DRAWINGS

A drive transmission in accordance with the invention will now be described by way of example with reference to the accompanying drawing in which:

FIG. 1 is a diagrammatic axial cross-section through one embodiment of the inventive drive transmission,

FIG. 2 is a diagrammatic axial cross-section through another embodiment of the inventive drive transmission,

FIG. 3 is a diagrammatic view of a modified version of the drive transmission shown in FIG. 2.

### DETAILED DESCRIPTION OF THE EMBODIMENTS

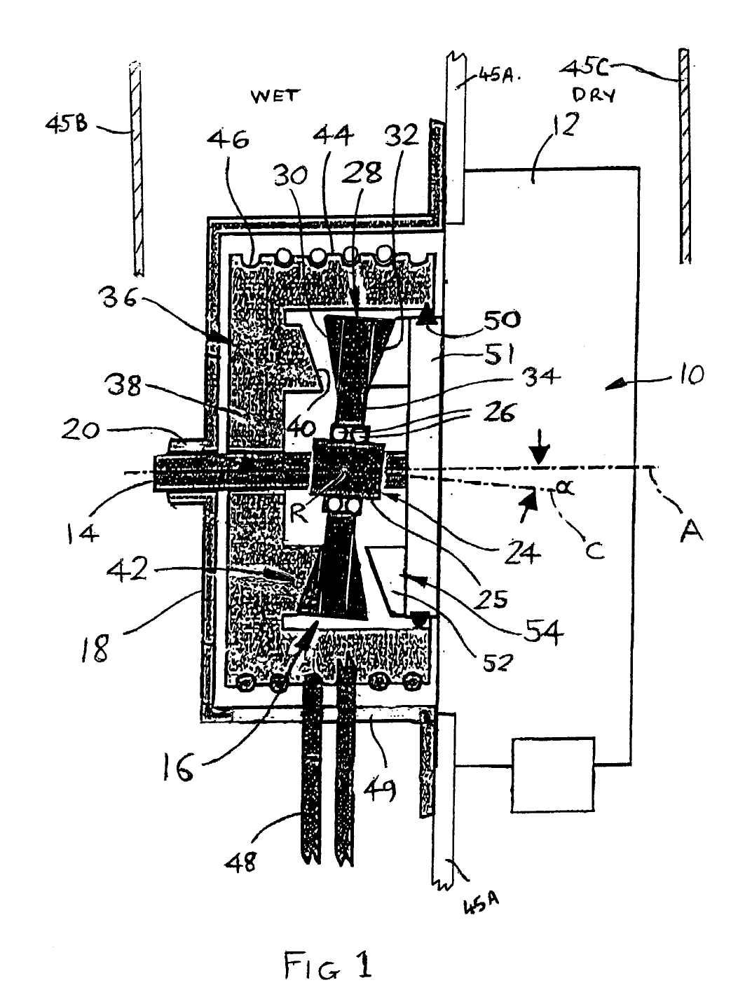

Referring to FIG. 1, an electric pancake motor 10 has a housing 12 and a rotary drive shaft 14. A drive transmission 16 is driven by the motor 10. A casing 18 (also known as a cable drum housing) having a top hat-shaped cross-section is mounted on an inner door skin 45A and is formed with a sleeve bearing 20, which rotatably supports a free end of the shaft 14 for added stability.

The door upon which the motor 10 and casing 18 are mounted comprises an outer door skin 45B and the inner skin 45A. The inner and outer door skins 45A, 45B define a void into which the window glass is lowered. From the perspective shown in FIG. 1, a door trim panel 45C is positioned on the right hand side of the inner door skin 45A. The area to the right of the inner door panel 45A is referred to as the dry side of the door, and the area to the left of the door inner door panel 45A is referred to as the wet side of the door. The inner door skin 45A therefore defines a barrier between the wet and dry sides of the door. The cable drum should be positioned substantially on the wet side of the door for the cables 48 to correctly lift and lower the associated window. Although the motor can also be positioned on the wet side of the door if necessary, the motor is preferably placed on the dry side of the door to minimize the risk of dampness adversely affecting the electrical components of the motor.

A hollow drive input member 24 of the drive transmission 16 receives the shaft 14 and is drivably connected thereto to rotate with the shaft 14 about an axis of rotation A. An outer portion 25 of the drive input member 24 is cylindrical and the longitudinal axis C of the cylinder is inclined at an angle α with respect to its axis of rotation A. The value of the angle is dependent upon the gear tooth height, where the height is a function of the mechanical strength of the gear teeth. The cylindrical outer portion 25 carries inner races of a pair of journal bearings 26, the outer races of which carry a first gear 28 having first and second sets of bevel teeth 30, 32 arranged coaxially on opposite sides of the input member 24. In the embodiment shown, the teeth 30, 32 are disposed on opposite faces of a plate 34 mounted on the outer races of the bearings 26. Other suitable types of journal bearings 26 may be used instead of the ball bearings shown in this example.

A drum 36 has an end section 38 that is rotatably mounted on the shaft 14 on a suitable journal bearing (not shown). The end section 38 has a circle of bevel teeth 40 to form a second gear, generally indicated at 42. The bevel teeth 40 are integrally formed with the drum 36 in this embodiment from, for example, injection molded plastic. The bevel teeth 30, 40 of the first and second gears 28, 42 respectively are constantly engaged with each other, as shown in FIG. 1. In the embodiment shown, the number of bevel teeth 30 in the first gear 28 is different from the number of bevel teeth 40 in the second gear 42, although the difference may only be one tooth. The drum 36 has a periphery 44 formed with a helical groove 46 for driving a cable 48 that raises and lowers a window in a vehicle door. Parts of the door are shown diagrammatically at 45. The cable 48 passes through an aperture 49 in the casing 18.

An open end of the drum 36 makes sealing contact with a peripheral seal 50 on a circular plate 51 that non-rotatably mounted on the motor housing 12. The plate 51 has a circle of bevel teeth 52 thereon to form a third gear indicated generally at 54. The third gear 54 is constantly engaged with the first gear 28. The second and third gears 42, 54 are coaxial with the axis of rotation A. The seal 50 helps ensure that the gears 28, 42, 54 operate in a clean environment housed within the drum 36. Housing the gears 28, 42, 54 within the drum 36 also ensures that the drive transmission structure remains compact.

A further seal (not shown) may be provided between the drum 36 and the casing 18 to ensure that the gears 28, 42, 54 are not contaminated by water or other foreign matter. In the embodiment shown, the number of bevel teeth 32 on the first gear 28 is equal to the number of bevel teeth 52 of the third gear 54.

As the shaft 14 rotates, the angled cylindrical member 24 rotates in unison with the shaft 14 and causes the first gear 28 to rock back and forth, or nutate. This nutating motion causes the first gear 28 to remain constantly engaged with the second and third gears 42, 54. The rocking takes place about a center R on the axis A. Pitch lines (not shown) of the engaging gears, when extended inward, pass through the center R. In that respect, it should be noted that respective pitch lines of the meshing gears are maintained in contact with each other. Because the number of teeth 32 in the first gear 28 is the same as the number of teeth 52 in the stationary third gear 54, the third gear 54 prevents rotation of the nutating first gear 28 about the axis A. Because the number of first set teeth 30 in the first gear 28 is different from the number of teeth 40 in the second gear 42, the nutating first gear 28 imparts a very slow rotary speed to the second gear 42, and therefore to the drum 36, when compared to the rotational speed of the shaft 14 on which the drum 36 is rotatably mounted.

If desired, the number of teeth 32 in the second set in the first gear 28 may be different from the number of teeth 52 in the third gear 54. In such a case, the first gear 28 will rotate about the axis A during nutation. The number of teeth 30 in the first set in the first gear 28 and the number of teeth 40 in the third gear 54 will then be selected based on the desired reduction ratio. Therefore, the third gear 54 can be used to control rotary movement of the first gear 28 during nutation either by causing the first gear 28 to rotate about the axis A or by preventing rotation of the first gear 28 completely.

The reduction ratio R is calculated from the formula:

$$R = \frac{1}{1 - {n}_{2} \cdot {n}_{3} / {n}_{1} \cdot {n}_{4}}$$

Where

n1=number of teeth 32 in the first gear 28

n2=number of teeth 52 in the third gear 54

n3=number of teeth 30 in the first gear 28

n4=number of teeth 40 in the second gear 42

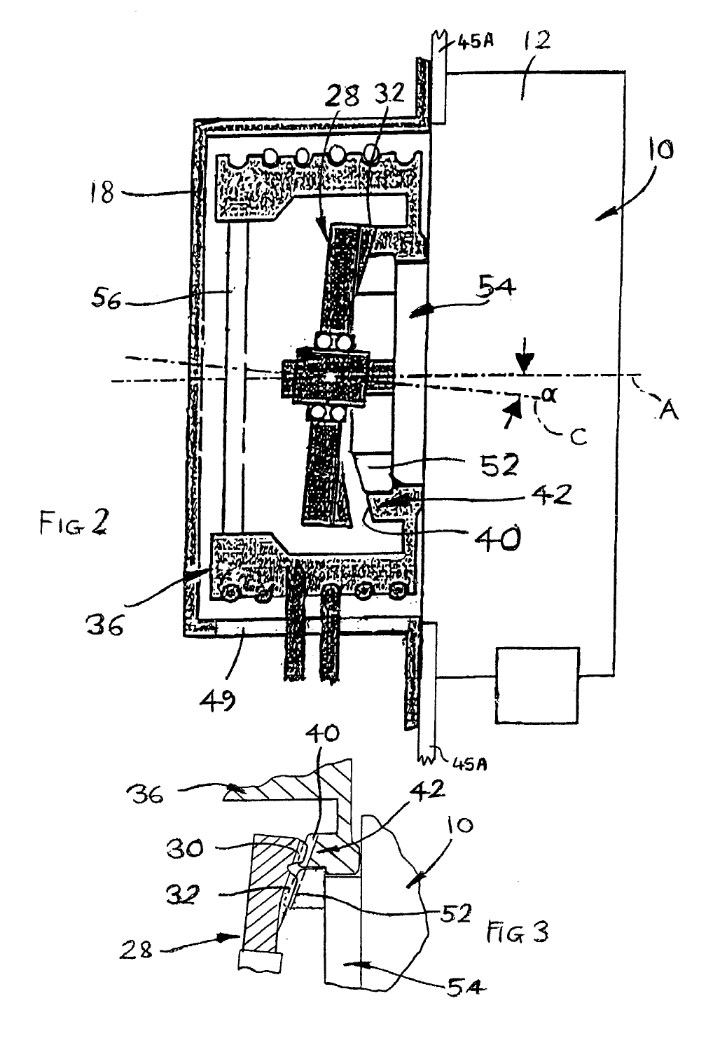

Referring to FIG. 2, parts corresponding to parts shown in FIG. 1 carry the same reference numerals and will not be described again in detail.

FIG. 2 illustrates a drive transmission according to another embodiment of the invention. In the embodiment of FIG. 2, the nutating first gear 28 has a single set of teeth 32 that meshes simultaneously with the teeth 40 of the second gear 42 on the drum 36 and with the teeth 52 of the stationary third gear 54. In this embodiment, the drum orientation 36 is reversed from the previous embodiment and is mounted for rotation on the outside of the third gear 54. A suitable journal bearing (not shown) is provided to support the drum 36, and the drum 36 may be sealed against the third gear 54 if necessary. The opposite end of the drum 36 is closed by a blanking plate 56 to protect the gears 28, 42, 54 from contaminants. Like the embodiment shown in FIG. 1, the drum 36 can be used to drive any device, such as a cable 48 for operating a vehicle window. In the illustrated example, the cable 48 passes through an aperture 49 in a casing 18.

In this embodiment, the number of teeth 40 of the second gear 42 differs from the number of teeth 52 in the stationary third gear 54 by at least one. The number of teeth 32 in the first gear 28 may be the same as the number of teeth in either of the other gears 42, 54. Alternatively, the number of teeth in the first gear 28 may be different from the number of teeth in both of the other gears 42, 54, if desired. The relative number of teeth among all the gears is selected based on the desired operation of the drive transmission.

The reduction ratio R in the embodiment of FIG. 2 is defined by the formula:

$$R = \frac{1}{1 - {n}_{2} / {n}_{4}}$$

Where

n1=number of teeth 32 in the first gear 28

n2=number of teeth 52 in the third gear 54

n4=number of teeth 40 in the second gear 42

It can be seen that the function of the first and second sets of teeth 30 and 32 in the first gear 28, respectively, in the embodiment shown in FIG. 1 is performed solely by the single set of teeth 32 shown in FIG. 2.

A modification of the embodiment of FIG. 2 is shown in FIG. 3 and involves providing the first gear 28 with two sets of teeth 30, 32 that engage with the teeth 40, 52 of the second and third gears 42, 54 respectively. The number of first set teeth 30 will be different from the number of second set teeth 32. This can be achieved by, for example, die casting or injection molding the first gear 28 to form the two sets of teeth 30, 32.

The reduction ratio R in this embodiment is given by the formula:

$$R = \frac{1}{1 - {n}_{2} \cdot {n}_{3} / {n}_{1} \cdot {n}_{4}}$$

Where

n1=number of teeth 32 in the first gear 28

n2=number of teeth 52 in the third gear 54

n3=number of teeth 30 in the first gear 28

n4=number of teeth 40 in the second gear 42

Note that in an alternative embodiment, the angled cylindrical member 24 can be integrated with the shaft 14.

In a yet a further embodiment, the cylindrical drive input member 24 can be made with a central hole that is parallel to the outer portion 25 of the input member 24 and that is larger in internal diameter than the external diameter of the shaft 14. This type of cylindrical member 24 can be slid onto the shaft 14. Because of its larger hole compared with the shaft diameter, the drive input member 24 can be tilted at an angle α and then secured in this tilted position relative to the shaft 14, causing the axis of rotation of the drive input member 24 to be included relative to the axis of rotation of the shaft 14. This enables the inclined portion of the drive input member 14 to impart rocking motion to the first gear 28 without imparting rotary motion.

While the examples described above focus on a structure having a drum 36 and a cable 38, the drum 36 may be replaced by an arm in an arm and sector regulator, which is frequently used as part of a mechanism for raising and lowering a vehicle window. Because high torque is required in such an arrangement (for example 40 Nm), the embodiment of FIG. 1 is preferred to generate such high torques. In such a case, the number of teeth 30, 40 of the first and second gears 28, 42 could be the same and the number of teeth 32, 52 of the first and third gears 28, 54 could be different to provide a reduction ratio at the input side of the transmission (that is, between the first and third gears 28 and 54) rather than at the output side (that is, between the first and second gears 28 and 42). This arrangement would allow a strong output gearing arrangement to handle the high torque required while still permitting the use of a less robust input gearing arrangement to handle the low torque at the input side of the transmission.

By using a non-rotatable third gear to restrain rotary motion of the first gear, the inventive structure provides a compact drive transmission structure by eliminating the need for extra structures to restrain rotation and mount a rockable gear. As explained above, the use of two sets of teeth on opposite sides of a single gear helps maintain a compact transmission structure. Further, engaging second and third gears on the same side of a first gear also provides the same functionality while preserving a compact arrangement. The inventive structure allows the drive transmission to be are short in the direction of axis A when compared to its radial size, making it ideal for use with pancake motors in areas where space is restricted, such as in vehicle doors. Moreover, the inventive drive transmission is less complex and more reliable than prior art drive transmissions.

It should be understood that various alternatives to the embodiments of the invention described herein may be employed in practicing the invention. It is intended that the following claims define the scope of the invention and that the method and apparatus within the scope of these claims and their equivalents be covered thereby.

1. A drive transmission, comprising:
a drum;
a drive input member;
a first gear driveable by the drive input member, wherein the first gear nutates when driven by the drive input member; and
a second gear engaged with the first gear to provide a rotary drive output, wherein the second gear is drivably connected to the drum.

2. The drive transmission of claim 1, further comprising a fixed third gear that controls rotary motion of the first gear during nutation of the first gear.

3. The drive transmission of claim 2, wherein the first, second and third gears are housed within the drum.

4. The drive transmission of claim 2, wherein the third gear has teeth that engage with teeth in the first gear to control rotary motion of the first gear.

5. The drive transmission of claim 2, wherein the second and third gears are coaxial with respect to each other.

6. The drive transmission of claim 2, wherein the first gear is positioned between the second and third gears in an axial direction.

7. The drive transmission of claim 6, wherein the first gear has a first set of teeth engaged with teeth on the second gear and has a second set of teeth engaged with teeth on the third gear.

8. The drive transmission of claim 7, wherein the first and second sets of teeth are arranged on opposite sides of the first gear.

9. The drive transmission of claim 2, wherein the second and third gears are arranged on a same side of the first gear.

10. The drive transmission of claim 9, wherein the first gear has teeth on one side, and wherein the set of teeth engage with teeth on both the second and third gears.

11. The drive transmission of claim 10, wherein the first gear has a first set of teeth and a second set of teeth that are both disposed on the one side, wherein the first set of teeth engages with teeth on the second gear and the second set of teeth engages with teeth on the third gear.

12. The drive transmission of claim 1, wherein the first gear and the second gear have a different number of teeth.

13. The drive transmission of claim 1, wherein the first gear nutates about an axis of rotation of the drive input member.

14. The drive transmission of claim 1, wherein the drive input member is inclined with respect to its axis of rotation and wherein the first gear is mounted on the inclined portion of the drive input member.

15. The drive transmission of claim 14, wherein the drive input member comprises a cylindrical portion having an axis inclined with respect to the axis of rotation of the drive input member.

16. The drive transmission of claim 1, wherein the drum is rotatable about the axis of rotation of the drive input member.

17. The drive transmission of claim 1, wherein the first and second gears are housed within the drum.

18. The drive transmission of claim 1, wherein the second gear is integrally formed with the drum.

19. The drive transmission of claim 1 further comprising a motor having a drive shaft that drives the drive input member.

20. The drive transmission of claim 19, wherein the drive input member has a cylindrical portion with a hole having an inner diameter that is greater than an outer diameter of the drive shaft, to allow the drive input member to tilt at an angle relative to its axis of rotation.

21. The drive transmission of claim 19, further comprising a casing attached to the motor and housing the drum, the drive input member, the first gear, and the second gear.

22. The drive transmission of claim 21, wherein the casing has a portion remote from the motor that rotatably supports part of the drive shaft of the motor.

23. A vehicle door, comprising:
an outer door skin;
an inner door skin spaced from the outer door skin and defining a dry side and a
wet side; and
a drive transmission comprising
a drum,
a drive input member that receives drive power from a motor, a first gear driveable by the drive input member, wherein the first gear nutates when driven by the drive input member,
a second gear engaged with the first gear to provide a rotary drive output, wherein the second gear is drivably connected to the drum, and
a motor having a drive shaft that drives the drive input member, wherein the drum is positioned substantially on the wet side and the motor is positioned substantially on the dry side.

24. A drive transmission, comprising:
a motor;
a drive input member that receives drive power from the motor and has an axis of rotation, wherein the drive input member is inclined with respect to its axis of rotation;
a first gear mounted on the drive input member, wherein the first gear nutates about the axis of rotation of the drive input member when driven by the drive input member;
a second gear engaged with the first gear to provide a rotary drive output, wherein the second gear is drivably connected to the drum, and wherein the first gear and the second gear have a different number of teeth;
a drum that houses the drive input member, the first gear, and the second gear, and is rotatable about the axis of rotation of the drive input member; and
a casing attached to the motor, wherein the casing houses the drum, the drive input member, the first gear, and the second gear.

25. The drive transmission of claim 24, further comprising a fixed third gear disposed inside the drum coaxial with the second gear such that the first gear is positioned between the second and third gears in an axial direction, wherein the fixed third gear controls rotary motion of the first gear during nutation of the first gear.

26. The drive transmission of claim 25, wherein the first gear has a first set of teeth engaged with teeth on the second gear and has a second set of teeth engaged with teeth on the third gear.

27. The drive transmission of claim 26, wherein the first and second sets of teeth are arranged on opposite sides of the first gear.

28. The drive transmission of claim 25, wherein the second and third gears are arranged on a same side of the first gear.

29. The drive transmission of claim 28, wherein the first gear has teeth on one side, and wherein the set of teeth engage with teeth on both the second and third gears.

30. The drive transmission of claim 29, wherein the first gear has a first set of teeth and a second set of teeth that are both disposed on the one side, wherein the first set of teeth engages with teeth on the second gear and the second set of teeth engages with teeth on the third gear.
